(19) United States
(12) Patent Application Publication
(10) Pub. No.: US 2012/0073695 A1
(43) Pub. Date: Mar. 29, 2012

(54) Tubular Casing Member with Helical Threads

(76) Inventor: Donald Patrick Muth, Edmond, OK (US)

(21) Appl. No.: 12/893,900

(22) Filed: Sep. 29, 2010

(51) Int. Cl. F16L 9/00

(52) U.S. Cl. 138/177

(57) ABSTRACT

A drilling device for use in a wellbore may include a tubular casing member having an external surface, and a thread member positioned on the exterior surface of the tubular casing member. The thread member may form a spiral on the exterior surface of the tubular casing member. The thread member may have a pentagonal cross section. The thread member may have a pitched cross section. The thread member may have a triangular cross-section. The thread member may have a convex cross-section. The thread member may have a concave cross-section. The thread member may have a rectangular cross section.

### FIELD OF THE INVENTION

The present invention relates to a helical, pitched threaded tubular casing member, and more particular, to a helical thread manufactured upon the tubular casing member itself.

### BACKGROUND

In the past, tubular casing members have smooth exterior surfaces, which may or may not include raised coupling ends called collars, and are fitted with separately included, attached centralizing components upon the outside to stabilize the casing tubular string within the center of the vertically drilled hole. Although the applied centralizers stabilize the tubular member within the center of the vertical hole, the attached centralizers create excessive drag upon the casing tubular string because of their respective geometry and shape, and this drag from the attached centralizers prevent the application of centralizers to the tubular casing string within directionally drilled holes.

The directionally drilled wellbore typically follows a substantial vertical downward pathway followed by a curved pathway which may extend downwards and outwards followed by a substantially horizontal pathway outwards. The horizontal length (ft) versus vertical length (ft) frequently exceeds a ratio of 0.5 in magnitude. Typical example would be a drilled hole with a true vertical depth of 10,000′ with a horizontal length of 5,000′ which brings the total measured depth to 15,000′ and a horizontal to vertical ratio of 0.5. After drilling a directional horizontal wellbore, the drill pipe, bottom hole assembly, and bit may be withdrawn from the well.

If the well is deemed commercially viable, then a tubular casing string including coupling joined casing tubular members, may be inserted into the wellbore and subsequently secured with cement. As the ratio of horizontal length versus vertical depth increases, it becomes increasingly difficult to insert the tubular casing string into the end of the drilled hole because the gravitational weight of the casing in the vertical portion is less than the gravitational weight of the horizontal section.

The application process of inserting the casing into the very bottom or end of the directionally drilled hole usually cannot continue indefinitely by simply utilizing gravitational weight and momentum as the horizontal to vertical ratio increases. Once the horizontal weight of the tubular casing string becomes greater than the vertical casing string weight, the casing tubular string may be rotated at the surface by the drilling rig equipment to effectively transfer weight to the bottom and to break the frictional forces between the horizontal portion of the tubular casing string and the horizontal portion of the wellbore. This rotation process does not come without a cost; rotation creates torque related problems within the tubular connections. At some point, the torque reaches a maximum limit in which the tubular casing string can no longer be rotated to the bottom of the drilled hole and no longer contains enough gravitational momentum from the vertical portion to reach the end of the directionally drilled hole.

These factors tend to limit the lateral length (horizontal length) extent of a majority of the directionally drilled horizontal wells. This limitation results in wasted money spent drilling a lateral section in which casing cannot secure as well as lost revenue from the hydrocarbon productive interval not captured.

U.S. Pat. No. 4,365,678 discloses a tubular member for a drill string used in the rotary drilling of deviated boreholes, which includes an outer circumferential surface which is contoured and adapted to engage the wall of the borehole so as to produce a longitudinally downward force on the drill bit upon rotation of the drill string. The tubular member may be a drill collar or section of drill pipe, wherein the contoured surface is constituted of a helical thread of a pitch which will impart a longitudinal force towards the drill bit upon rotation of the drill pipe or drill collar member.

### SUMMARY

A casing device for use in a previously drilled wellbore may include a tubular casing member having an external surface, and a thread member positioned on the exterior surface of the tubular casing member. The thread member may form a spiral on the exterior surface of the tubular casing member.

The thread member may have a pentagonal cross section.

The thread member may have a pitched cross section.

The thread member may have a triangular cross-section.

The thread member may have a convex cross-section.

The thread member may have a concave cross-section.

The thread member may have a rectangular cross section.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a sectional view of a casing member of the present invention;

FIG. 2 illustrates a partial cross-sectional view of the casing member of the present invention;

FIG. 3 illustrates a partial cross-sectional view of the casing member of the present invention;

FIG. 4 illustrates a partial cross-sectional view of the casing member of the present invention;

FIG. 5 illustrates a partial cross-sectional view of the casing member of the present invention;

FIG. 6 illustrates a first end view of the casing member of the present invention;

FIG. 7 illustrates a second end view of the casing member of the present invention.

The present invention relates to a mechanical device for the oil and gas industry.

The present invention addresses the problem of torque and drag reduction on tubular casing string for a more effective insertion of the tubular casing string in directionally drilled horizontal wellbore and for the more effective cementation bond between the tubular casing string and the well bore wall. The present invention relates to a helical, pitched threaded tubular casing member, and more particular, to a helical thread manufactured upon the tubular casing member itself which contains an exposure height equal to or greater than the maximum outer diameter of the casing tubular member or casing tubular member's coupling, in which the helical, raised, pitched, thread covers across the majority of the entire body of each member for the use in casing and cementing a drilled directional wellbore. The horizontal portion of the directionally drilled wellbore typically may not follow a straight 90 degree with respect to the vertical pathway substantially parallel to the earth's surface because of such factors as geological changes within the earth, faulting within the earth surface, operator errors in directing the drill bit and other interruptions. The horizontal pathway may vary between over 100 degrees in some cases and less than 45 degrees in other cases, and frequently may include changes in inclination from less than 90 degrees, to greater than 90 degrees, and back to less than 90 degrees during the course of a drilling a horizontal directional wellbore. The horizontal wellbore may also substantially change azimuthally in directional orientation to avoid hazards such as un-leased tracks, competitors leased tracks, and other obstructions. The inclination and azimuth directional variations create problematic situations for the insertion of the tubular casing string because the tubular casing string may navigate with difficulty throughout the culmination of all of the directional deviations within the directionally drilled wellbore.

Once the tubular casing string has been inserted into the bottom of the directionally drilled wellbore, it may be secured in place by cement which may be pumped down the center of the tubular casing string, through the end of the tubular casing string, and settle along the annulus between the inner diameter of the wellbore and the outer diameter of the tubular casing string. The weight of the tubular casing string and gravitational forces may prevent the cement from fully, evenly, and uniformly enveloping the annulus around the string and between the wellbore wall.

The tubular casing string rests upon the bottom side of the horizontal hole, and the cement distributes itself along the path of least resistance which is along the top side of the drilled hole. This creates problematic situations where the casing may be exposed to extremely corrosive and deteriorating conditions found within the horizontal hole from the earth which may lead to casing failure, leakage of hydrocarbons, escape of hazardous well stimulation chemicals and other problems.

The present invention achieves advantages based upon the raised, pitched, helical threads of a tubular casing member. A partial list follows:
a) Decreases the tubular casing string drag during the insertion process inside the directionally drilled hole.
b) Decreases the tubular casing string torque during the insertion process inside the directionally drilled hole.
c) Stabilizes the tubular casing string within the center of the directionally drilled hole.
d) Decreases the potential for damaging bending and buckling moments during the insertion process inside the directionally drilled hole
e) Increases the tubular casing string's ability to navigate through a directionally drilled hole.
f) Provides a more effective cementation bond in which the cement uniformly disperses around the tubular casing string within the directionally drilled hole.

The purpose of the present invention achieves torque and drag reduction on the tubular casing string for the more effective insertion of the tubular casing string in directionally drilled horizontal and vertical wellbore and for the more effective cementation bond between the tubular casing string and wellbore wall.

The force of gravity and weight of the tubular casing string may cause intense friction forces to develop between the bottom of the hole and the bottom outer diameter of the tubular casing string during the insertion process of a tubular casing string. The raised, pitched, helical threads decrease tubular casing drag by dramatically reducing the amount of surface contact area the tubular string has against the bottom of the drilled directional hole. The raised, pitched, helical threads also reduced the frictional drag forces by centralizing the tubular casing string within the center of the hole without the application of additional centralizer products.

High torque values are a major concern during the process of rotating the tubular casing string to the bottom of the directionally drilled hole. The rotational torque values may not exceed the ‘make-up’ torque values suitable for the connection coupling found within the tubular casing member. Excessive torque within the coupling connection leads to casing leaks and failures in which the tubular casing string fails and parts. The raised, pitched, helical threads of this invention decrease torque because of the reduced contact area between the tubular member's threads and the bottom of the directionally drilled wellbore. The threads apply a substantially longitudinal, axial pulling force as the tubular casing string is rotated from the surface and act as a screw could act being inserted into a piece of wood by a screw driver. The reductions in surface area, centralization within the center of the drilled horizontal hole, and the pulling action of the thread decrease the required surface torque to rotate the tubular casing string to and along the bottom of the wellbore. This positive attribute also enables the entire tubular casing string with raised, pitched, helical threads to navigate through the intense deviations associated with a directional horizontal wellbore.

The centralization provided by the raised, pitched, helical threads decrease the possibility of bending and buckling moments while attempting to insert the tubular casing string into the directionally drilled hole. The weight of vertical portion of the tubular casing string and gravitational momentum while attempting to insert the tubular casing string into the hole may create bending and buckling moments at the curve portion and elsewhere in the wellbore. The curved portion of the directional wellbore may include the largest amount of inclination deviation from vertical at 0 degrees to horizontal at 90 degrees and results in the largest decrease of effective weight transfer from the surface to the end of the tubular casing string. The raised, pitched, helical threads of the tubular casing string may allow the weight to more effectively transfer to the end of the tubular easing string by centralizing or urging the string within the center of drilled wellbore. The transfer of weight to the end point of the tubular casing string may reduce the risk of bending or buckling moments within the tubular casing string which may prevent the damage of the connection couplings, cause failures, and subsequently leak hazardous chemicals.

The thread member 103 which may include raised, pitched, helical threads along the outer diameter of the tubular casing string centralizes or urges the entire tubular casing string within the center of the hole for a substantially uniform cement configuration around the annulus between the inner wellbore wall and outer diameter of the tubular casing string. The raised, pitched, helical threads may create a swirling, turbulent motion while the pre-flush fluids are pumped prior to cementation and reduce the contamination of cement with wellbore mud cake. Moreover, the centralization of the tubular casing string within the wellbore urges the tubular casing string towards the center of the wellbore to decrease the amount of casing to formation contact and subsequent possibility of casing corrosion and failures.

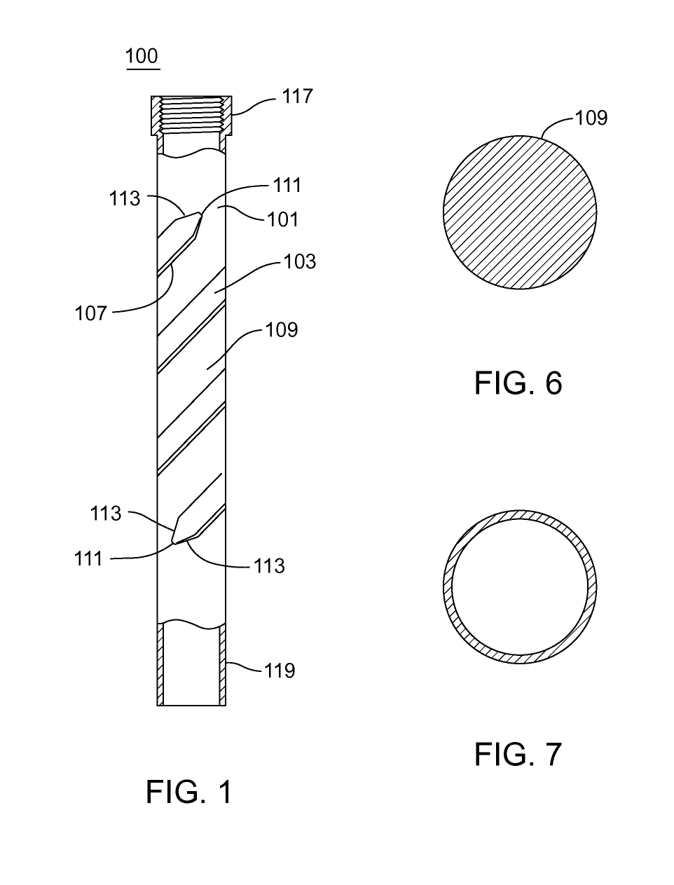

The present invention as illustrated in FIG. 1 may include a casing device 100 which may include a tubular casing member 101 which may be a longitudinal cylinder and may include an integral or applied by welding or other such appropriate attachment methods a raised, helical, pitched thread member 103 applied around the outer body of the tubular casing member 101 in a right hand twist for the application of clockwise rotation in which when rotated the raised, pitched thread will apply a longitudinal force in the general direction of the wellbore and towards the bottom of the directionally drilled horizontal well the force is substantially horizontal. The thread member 103 may be raised from the surface 109 from the tubular casing member 101 and the side surface 107 of the thread member 103 may be substantially perpendicular to the surface 109 of the tubular casing member 101. The thread member 103 may include opposing and inclined side surface 113 which may terminate in a point 111 in order to facilitate the rotation of the tubular casing member 101. The top surface 109 of the tubular casing member 101 may be substantially perpendicular to the side surface 107 or may be substantially curved in order to provide a pitch in thread member 103. Alternatively, the top surface 109 may include opposed inclined surfaces. The thread member 103 may extend around the surface 109 of the tubular casing member 101 to form a spiral. The raised, pitched, helical thread member 103 may contain a quarter revolutions, half revolution, full revolution or multiple revolutions per tubular member. The thread member 103 may cooperate with additional thread members 103 which may extend around the tubular casing member 101 in a parallel fashion.

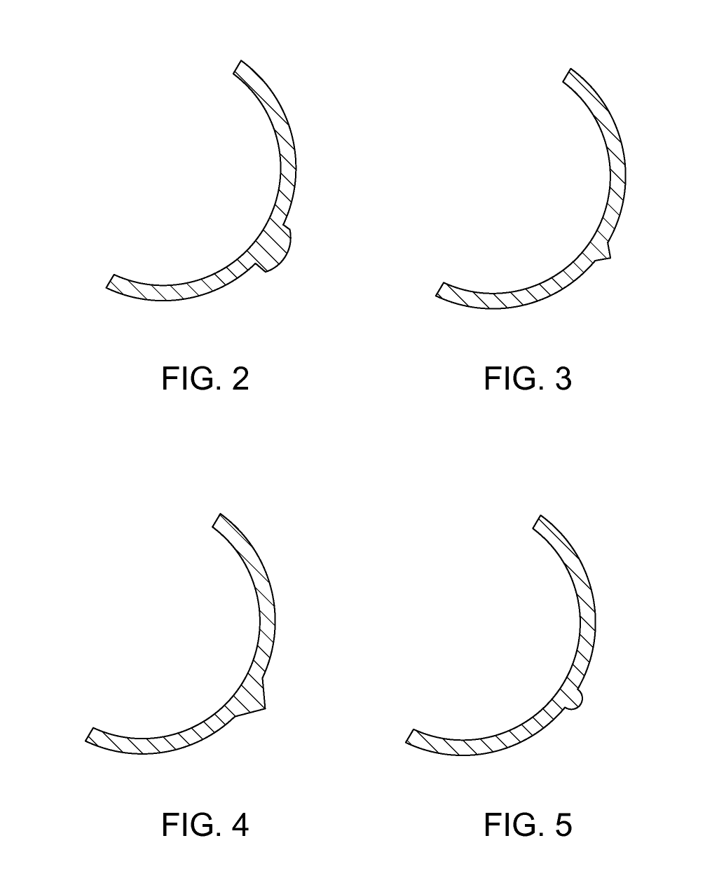

The cross sectional shape of the thread member 103 may be boxed, pentagonal as in FIG. 2, pitched as in FIG. 3, triangular as in FIG. 4, convex as in FIG. 5, concave or any other shape depending upon application. The thread member 103 may have a height which is substantially equal to or greater than the outer diameter of the coupling so that the thread member 103 extends radially beyond the coupling. The thread member 103 may be hollow or may be solid throughout the entire length of the tubular casing member 101. The connections types for attachment to the tubular casing member 101 may vary from long thread, short thread, high torque connection, buttress type and any other type of applicable connection. The thread members of connected tubular casing member 101 may or may not be aligned once a secured connection is achieved between the pin end 119 which may include male threads and box end 117 which may include female threads within the coupling to prevent a redundant distribution of each revolution(s), half revolution, or any type of revolution provided by the thread.

The length of the raised, pitched, helical, thread member 103 may vary with the length of the tubular casing member 101 but may not extend to the pin end for the application of connection make-up tongs and may not extend to the box end for the application of elevators and/or Casing Running Tool Applications. The raised, pitched, helical thread member 103 may constitute a small percentage of the overall outer surface area and may be suitable for a film of a friction reduction agent such as Teflon which may be applied by spray. Such an agent may be only applied to only the raised, pitched, helical thread member 103 to further reduce the friction factor of the outer contact surface area. FIG. 6 illustrates an end view of the box end 117 and FIG. 7 illustrates an end view of the pin end 119.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A drilling device for use in a wellbore, comprising:
a tubular casing member having an external surface;
a thread member positioned on the exterior surface of the tubular casing member;
wherein the thread member forms a spiral on the exterior surface of the tubular casing member.

2) A drilling device for use in a wellbore as in claim 1, wherein the thread member has a pentagonal cross section.

3) A drilling device for use in a wellbore as in claim 1, wherein the thread member has a pitched cross section.

4) A drilling device for use in a wellbore as in claim 1, wherein the thread member has a triangular cross-section.

5) A drilling device for use in a wellbore as in claim 1, wherein the thread member has a convex cross-section.

6) A drilling device for use in a wellbore as in claim 1, wherein the thread member has a concave cross-section.

7) A drilling device for use in a wellbore as in claim 1, wherein the thread member has a rectangular cross section.
